(19) United States
(12) Patent Application Publication
(10) Pub. No.: US 2023/0176561 A1
(43) Pub. Date: Jun. 8, 2023

(54) CONTROL DEVICE, CONTROL METHOD AND CONTROL PROGRAM

(71) Applicant: Nippon Telegraph and Telephone Corporation, Tokyo (JP)

(72) Inventors: Aiko OI, Musashino-shi, Tokyo (JP); Ryosuke SATO, Musashino-shi, Tokyo (JP); Yuichi SUTO, Musashino-shi, Tokyo (JP)

(21) Appl. No.: 17/923,728

(22) PCT Filed: May 21, 2020
(86) PCT No.: PCT/JP2020/020122

§ 371 Date: Nov. 7, 2022

(51) Int. Cl. G05B 23/02

(52) U.S. Cl. CPC G05B 23/027; G05B 23/0275; G05B 23/0218

(57) ABSTRACT

The control apparatus 1 includes a control unit 21 that controls execution of a workflow including a handling execution process when an alarm indicating a failure is occurred, and an instruction unit that instructs the control unit 21 to stand by execution of the handling execution process when the handling execution process is capable of being executed before a monitoring period started in response to occurrence of an alarm indicating the failure or a recovery expires, and when the monitoring period expires, execute the handling execution process in a case where an alarm that is occurred most recently indicates the failure, and cancel the execution of the handling execution process in a case where the alarm that is occurred most recently indicates the recovery.

### TECHNICAL FIELD

The present disclosure relates to a control apparatus, a control method, and a control program.

### BACKGROUND ART

In recent years, efforts related to automation of work have been active in order to improve work efficiency. In the case of the communication industry, there is a case where a workflow engine or the like is introduced to automate operation in a failure handling work in a communication network. An operation on a failure of the apparatus is described in advance as a workflow. In response to occurrence of an alarm indicating the failure, a computer handles the failure according to the workflow, so that the automation of work is achieved.

For accurate failure handling, there is a technology of analyzing alarm messages and aggregating a plurality of alarms (see NPL 1). The technology described in NPL 1 suppresses the same alarm or a large number of alarms, and achieves execution of an action for an alarm that has been occurred.

### CITATION LIST

### Non Patent Literature

NPL 1: Jim Brown, “Working with SEC—the Simple Event Correlator”, [online], Nov. 23, 2003, [searched on May 12, 2020], Internet <URL: http://simple-evcorr.sourceforge.net/SEC-tutorial/article.html>

### SUMMARY OF THE INVENTION

### Technical Problem

Unfortunately, according to the technology described in NPL 1, it is not possible to execute fine operations such as instructing to execute a workflow according to an alarm occurrence status in the latest predetermined time. As a result, it is not possible to appropriately handle a failure, such as executing one handling action a plurality of times.

The present disclosure has been made in view of the above circumstances, and an object of the present disclosure is to provide a technology capable of appropriately handling a failure.

### Means for Solving the Problem

A control apparatus of one aspect of the present disclosure includes a control unit that controls execution of a workflow including a handling execution process when an alarm indicating a failure is occurred, and an instruction unit that instructs the control unit to stand by execution of the handling execution process when the handling execution process is capable of being executed before a monitoring period started in response to occurrence of an alarm indicating the failure or a recovery expires, and when the monitoring period expires, execute the handling execution process in a case where an alarm that is occurred most recently indicates the failure, and cancel the execution of the handling execution process in a case where the alarm that is occurred most recently indicates the recovery.

A control method of one aspect of the present disclosure includes by a computer, controlling execution of a workflow including a handling execution process when an alarm indicating a failure is occurred, by the computer, instructing to stand by execution of the handling execution process when the handling execution process is capable of being executed before any one of monitoring periods each started in response to occurrence of an alarm indicating the failure or a recovery expires and when the monitoring periods expire, by the computer, instructing to execute the handling execution process in a case where an alarm corresponding to a monitoring period most recently expired of the monitoring periods indicates the failure, and cancelling the execution of the handling execution process in a case where the alarm corresponding to the monitoring period most recently expired indicates the recovery.

One aspect of the present disclosure is a control program that causes a computer to operate as the control apparatus.

### Effects of the Invention

According to the present disclosure, it is possible to provide a technology capable of appropriately handling a failure.

### BRIEF DESCRIPTION OF DRAWINGS

FIG. 1 is a diagram illustrating functional blocks of a control apparatus according to an embodiment of the present disclosure.

FIG. 2 is a diagram illustrating an example of a data structure of workflow data.

FIG. 3 is a diagram illustrating an example of a data structure of monitoring data.

FIG. 4 is a diagram illustrating an example of a data structure and data of handling time data.

FIG. 5 is a flowchart illustrating control processing by a control unit.

FIG. 6 is a flowchart illustrating instruction processing by an instruction unit.

FIG. 7 is a flowchart illustrating calculation processing by a calculation unit.

FIG. 8 is a diagram illustrating a hardware configuration of a computer used in the control apparatus.

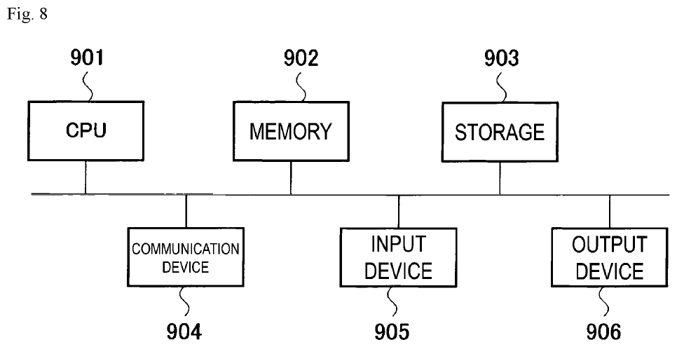

### DESCRIPTION OF EMBODIMENTS

Hereinafter, an embodiment of the present disclosure will be described with reference to the drawings. Note that the same portions in the description of the drawings will be denoted by the same reference numerals and signs, and the description thereof will be omitted.

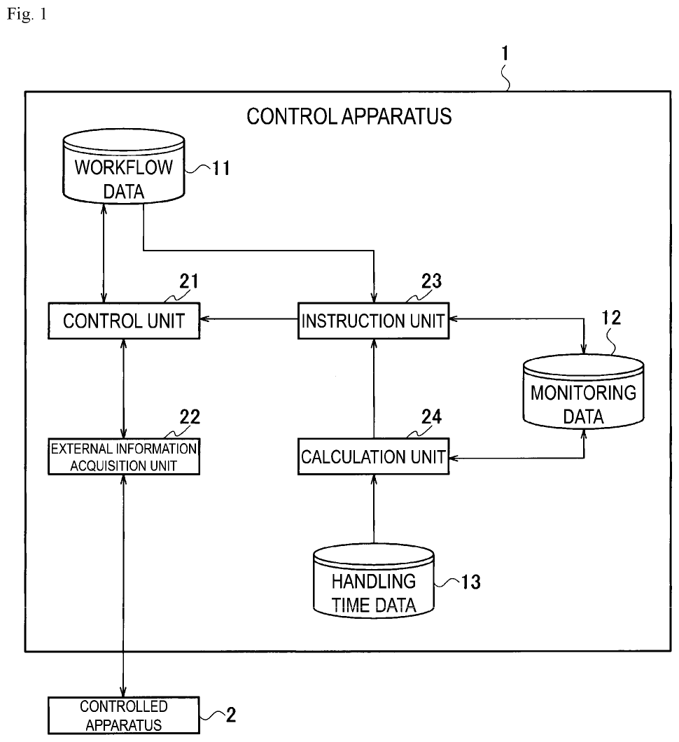

Control Apparatus When a failure occurs in a controlled apparatus 2, a control apparatus 1 illustrated in FIG. 1 handles the failure according to a predetermined workflow. The controlled apparatus 2 is an apparatus for providing a network service and is a control target of failure handling by the control apparatus 1.

In an embodiment of the present disclosure, a case where the workflow includes a pre-confirmation process, a handling execution process, and a post-confirmation process will be described. The control apparatus 1 confirms a failure situation in the pre-confirmation process. The control apparatus 1 handles the controlled apparatus 2 in the handling execution process. The control apparatus 1 confirms the result of the handling execution process and the like in the post-confirmation process.

In particular, the control apparatus 1 according to the embodiment of the present disclosure adjusts the timing of executing the handling execution process in consideration of the occurrence status of each alarm of a failure or a recovery. For example, even in a situation where an alarm of a failure and an alarm of a recovery occur continuously, the control apparatus 1 executes the handling execution process at an appropriate timing.

In the embodiment of the present disclosure, a monitoring period calculated by a predetermined calculation method is set after an alarm related to the controlled apparatus 2 is occurred. When alarms occur continuously, the control apparatus 1 stands by execution of the handling execution process during the monitoring period corresponding to any of the alarms. The control apparatus 1 executes or cancels the handling execution process after the monitoring period corresponding to each alarm ends. In addition, even before the expiration of the monitoring period corresponding to each alarm, the control apparatus 1 executes the handling execution process when the alarm occurrence status satisfies a predetermined condition.

In the embodiment of the present disclosure, an alarm means an event that indicates a change or abnormality of a network service and triggers the start of a workflow for handling a failure. In addition to the alarm issued by the controlled apparatus 2, the alarm may be a report from an operator or may be information observed by an apparatus connected to the controlled apparatus 2. The information observed by the apparatus connected to the controlled apparatus 2 is, for example, information indicating an abnormality of a traffic distribution amount on a communication network, information indicating a change in a connection configuration between apparatuses, and the like.

The control apparatus 1 includes workflow data 11, monitoring data 12, handling time data 13, a control unit 21, an external information acquisition unit 22, an instruction unit 23, and a calculation unit 24. The workflow data 11, the monitoring data 12, and the handling time data 13 are pieces of data stored in a memory 902 or a storage 903. The control unit 21, the external information acquisition unit 22, the instruction unit 23, and the calculation unit 24 are functional units implemented in the control apparatus 1 by execution of the CPU 901.

The control apparatus 1 defines a workflow to be activated when an alarm related to the controlled apparatus 2 is occurred. The workflow specifies the detail of execution by the control apparatus 1 in each of the pre-confirmation process, the handling execution process, and the post-confirmation process. The workflow may be defined for each failure location, failure type, or the like occurring in the controlled apparatus 2.

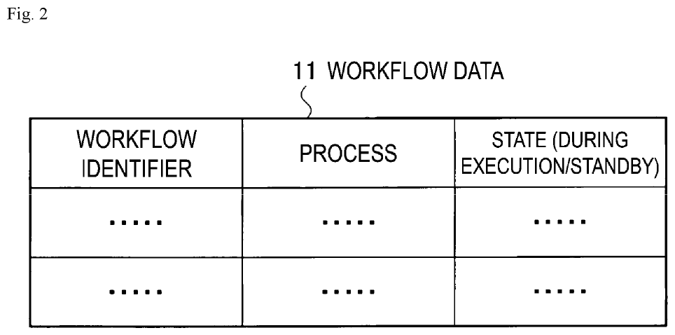

The workflow data 11 is data that stores an identifier of a workflow activated by the control unit 21 to be described below and a progress situation thereof when an alarm related to the controlled apparatus 2 is occurred. As illustrated in FIG. 2, the workflow data 11 associates, as a progress situation of the workflow, a process and a state of the process such as being executed or standby with a workflow identifier for identifying an activated workflow.

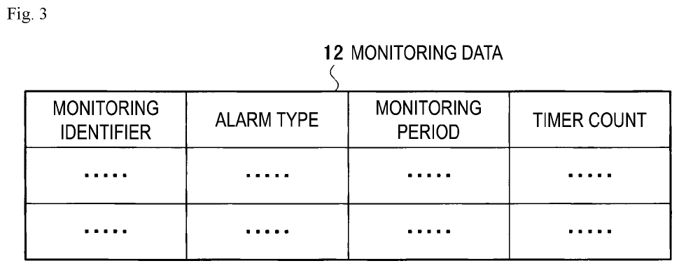

The monitoring data 12 is data of a monitoring period set in the control apparatus 1. As illustrated in FIG. 3, the monitoring data 12 associates a monitoring identifier for identifying a set monitoring period, an alarm type which is a trigger for setting the monitoring period, the monitoring period, a timer count for specifying a time from the start of the monitoring period, and the like. The alarm type may specify at least either a failure or a recovery and may be associated with more detailed information.

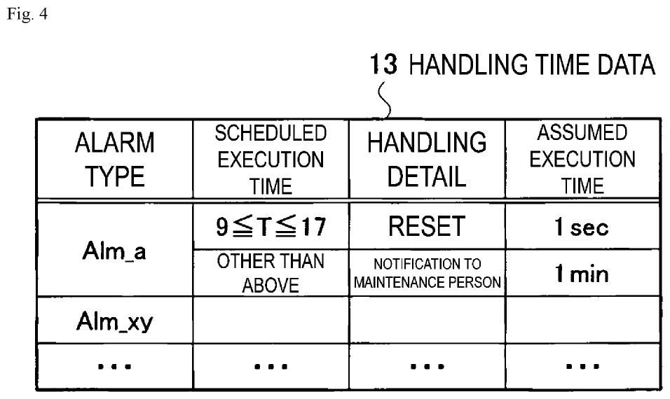

The handling time data 13 specifies the time used from the start to the end of the handling execution process. As illustrated in FIG. 4, the handling time data 13 associates an assumed execution time with an alarm type. In addition, in a case where the handling differs depending on the execution time of the handling execution process, the handling time data 13 may associate the handling detail with the assumed execution time for each alarm type and each scheduled execution time.

When an alarm indicating a failure is occurred, the control unit 21 controls execution of a workflow including a handling execution process. When acquiring an alarm indicating a failure of the controlled apparatus 2 from the external information acquisition unit 22, the control unit 21 sequentially executes each process of the workflow for handling the failure. In the embodiment of the present disclosure, the control unit 21 follows an instruction from the instruction unit 23 to be described below in execution of the handling execution process among the respective processes of the workflow. The control unit 21 updates the workflow data 11 according to the execution status of the workflow.

Specifically, when there is an instruction of standby from the instruction unit 23 in performing the handling execution process, the control unit 21 stands by execution of the handling execution process. Thereafter, when there is an instruction of execution from the instruction unit 23, the control unit 21 executes the handling execution process. In addition, when there is an instruction of cancellation from the instruction unit 23, the control unit 21 cancels the execution of the handling execution process and executes the subsequent post-confirmation process.

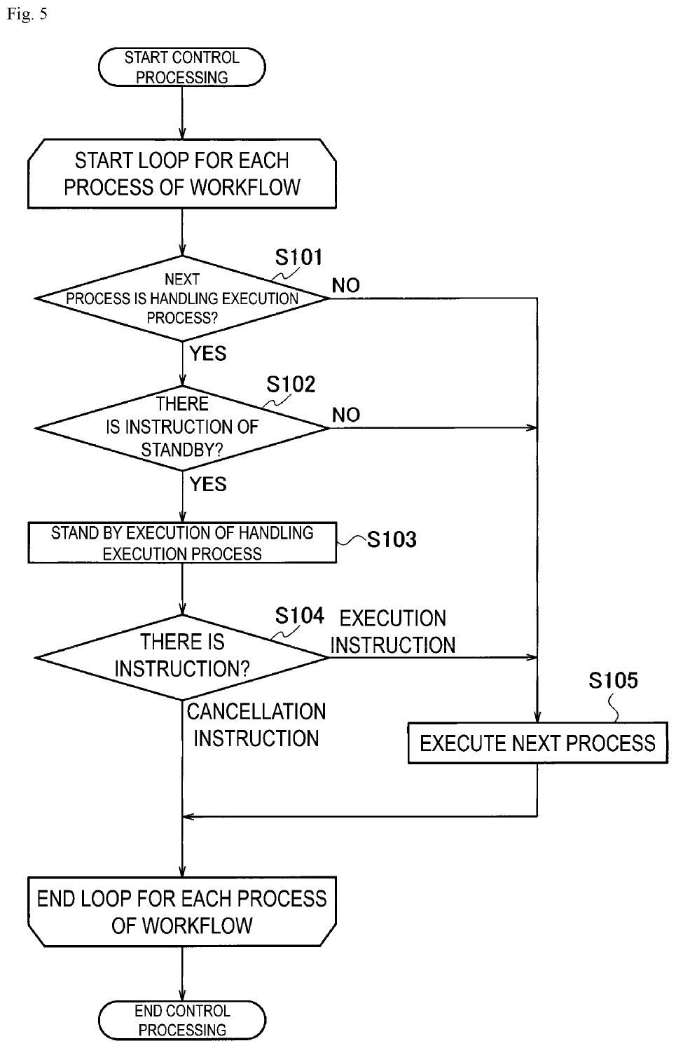

Control processing by the control unit 21 will be described with reference to FIG. 5. The order of the processing operations illustrated in FIG. 5 is an example, and the present disclosure is not limited thereto.

When an alarm indicating a failure is occurred in the controlled apparatus 2, the processing operations of steps S101 to S105 is executed for each process of the workflow for handling the failure.

First, in step S101, the control unit 21 determines whether a process to be performed next is a handling execution process. In a case where the process to be executed next is the pre-confirmation process or the post-confirmation process, the control unit 21 performs the process in step S105.

In a case where the process to be executed next is the handling execution process, in step S102, the control unit 21 determines whether there is an instruction of standby from the instruction unit 23. In a case where there is no instruction of standby, the control unit 21 executes the handling execution process in step S105. On the other hand, in a case where there is an instruction of standby, in step S103, the control unit 21 stands by execution of the handling execution process until there is an instruction from the instruction unit 23.

When there is an instruction from the instruction unit 23 in step S104, the control unit 21 performs processing according to the instruction. In the case of an instruction of execution of the handling execution process, the control unit 21 executes the handling execution process in step S105. On the other hand, in the case of an instruction of cancellation the handling execution process, the execution of the handling execution process during standby is canceled, and the processing returns to step S101 to execute the next process.

When the processing operations of steps S101 to S105 ends for each process of the workflow, the control unit 21 ends the processing for this workflow.

In addition, when an instruction to execute a new workflow is input from the instruction unit 23 after executing the handling execution process of a certain workflow, the control unit 21 executes a workflow different from the workflow executed immediately before. For example, in a case where the failure is not resolved by the workflow handling execution process executed previously, and a different handling is to be performed, the control unit 21 executes a new workflow according to an instruction from the instruction unit 23.

The external information acquisition unit 22 is an interface with the controlled apparatus 2. The external information acquisition unit 22 acquires information such as an alarm of the controlled apparatus 2 and inputs the information to the control unit 21. In addition, the external information acquisition unit 22 inputs a command such as confirmation and handling from the control unit 21 to the controlled apparatus 2, acquires an execution result of the command in the controlled apparatus 2, and inputs the acquired result to the control unit 21.

The instruction unit 23 inputs, to the control unit 21, an instruction regarding execution of the handling execution process by the control unit 21 according to the alarm occurrence status. When an alarm indicating a failure or a recovery is occurred in the controlled apparatus 2, the instruction unit 23 sets a monitoring period for the alarm. The instruction unit 23 updates the monitoring data 12 according to the alarm occurrence status. The monitoring period is set every time an alarm is occurred. In the embodiment of the present disclosure, the monitoring period is calculated by the calculation unit 24 described below.

In a case where the handling execution process can be executed before the monitoring period started in response to the occurrence of the alarm indicating a failure or a recovery expires, the instruction unit 23 instructs standby the execution of the handling execution process. In a case where alarms indicating a failure or a recovery occur continuously and a plurality of monitoring periods are provided in parallel, even if the handling execution process can be executed before each monitoring period expires, standby of execution of the handling execution process is instructed. In a situation where alarms indicating a failure and alarms indicating a recovery are repeatedly and continuously occurred, if the handling execution process is executed every time an alarm indicating a failure is occurred, the handling execution process is repeated a plurality of times. Therefore, when an alarm is occurred, the instruction unit 23 provides a monitoring period for detecting a subsequent alarm and causes execution of the handling execution process to stand by until the occurrence of the alarm during the monitoring period is settled.

When each monitoring period expires, the instruction unit 23 determines an instruction to be input to the control unit 21 according to the type of alarm that has been occurred most recently. In a case where the alarm that has been occurred most recently indicates a failure, specifically, in a case where a state in which no alarm is occurred continues for a predetermined time after the alarm of the failure is occurred, it is considered to be the controlled apparatus 2 is in a failure state, and thus the instruction unit 23 instructs the control unit 21 to execute the handling execution process. As a result, even in a situation where alarms indicating a failure or a recovery continuously occur, execution of the handling execution process can be suppressed to only one.

On the other hand, in a case where the alarm that has been occurred most recently indicates a recovery, specifically, in a case where a state in which no alarm is occurred continues for a predetermined time after the alarm of the recovery is occurred, it is considered to be the failure of the controlled apparatus 2 has spontaneously recovered, and thus the instruction unit 23 instructs cancellation of execution of the handling execution process. In a case where the spontaneous recovering of the failure is considered from the alarm occurrence status, it is possible to avoid execution of an unnecessary handling by canceling the handling execution process of the already activated workflow.

After instructing to stand by execution of the handling execution process, the instruction unit 23 instructs execution of the handling execution process when the alarm occurred during the monitoring period satisfies a predetermined condition. For example, in a case where handling a failure immediately, such as when a specific alarm is continuously occurred, while standing by execution of the handling execution process, the instruction unit 23 instructs the control unit 21 to execute the handling execution process without waiting for expiration of each monitoring period. Here, the predetermined condition is a condition indicating that immediate handling of a failure is taken, and for example, the predetermined condition is specified by the number of times or frequency of occurrence of a specific alarm, an elapsed time from the occurrence of the alarm, a failure detail indicated by the alarm, and the like. When the alarm occurrence status meets a predetermined condition, the instruction unit 23 instructs execution of the handling execution process before expiration of the monitoring period. As a result, the instruction unit 23 can obtain both an effect of avoiding a situation in which the handling execution process is repeated a plurality of times by outputting the instruction regarding the handling execution process after the expiration of the monitoring time and an effect of immediately handling the failure state of the controlled apparatus 2 by outputting the instruction of execution of the handling execution process without waiting for the expiration of the monitoring time.

In a case where the alarm occurred after the execution of the handling execution process indicates that the failure that has triggered the execution of the workflow including the handling execution process has not been resolved, the instruction unit 23 instructs execution of a new workflow. The handling execution process of the new workflow indicates a handling detail different from the handling execution process of the workflow that has been already executed. Even when the control unit 21 executes the handling execution process, there is a case where the failure that has triggered the execution of the workflow is not resolved, and a similar alarm is occurred. In such a situation, in order to avoid the control unit 21 from executing the same handling execution process again, the instruction unit 23 instructs the control unit 21 to execute a new workflow. The case where the failure that has triggered the execution of the workflow including the handling execution process has not been resolved is, for example, a case where an alarm indicating a failure similar to the previously occurred failure is occurred within a predetermined time after the execution of the handling execution process.

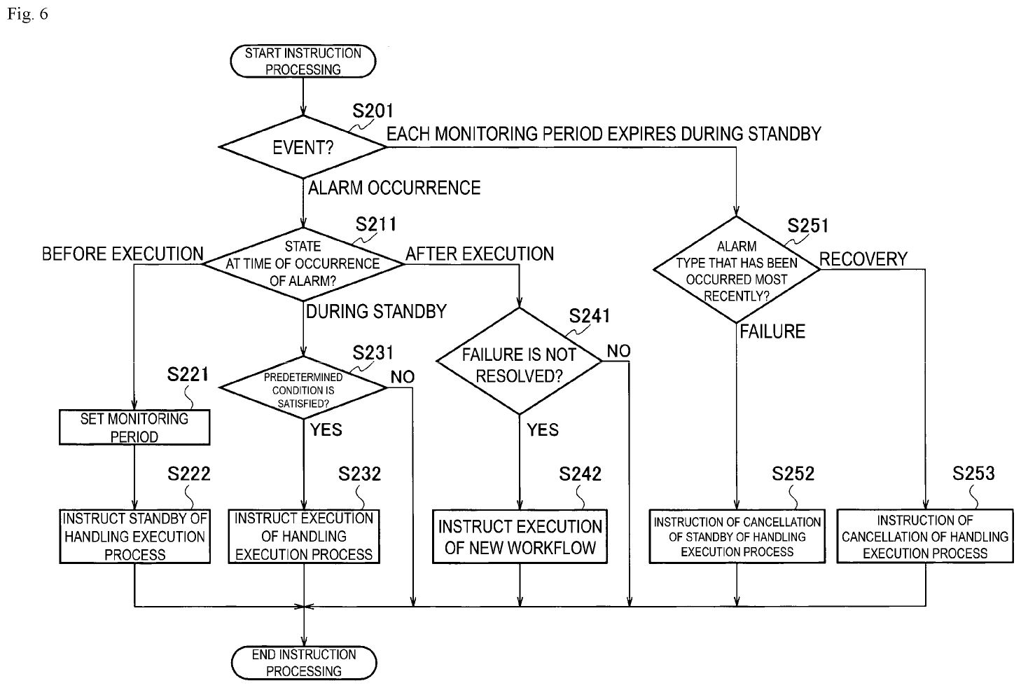

Instruction processing by the instruction unit 23 will be described with reference to FIG. 6. The order of the processing illustrated in FIG. 6 is an example, and the present disclosure is not limited thereto.

In step S201, the instruction unit 23 divides the processing according to the occurred event. In a case where an alarm is occurred, the processing proceeds to step S211, and in a case where each monitoring period expires while standing by execution of the handling execution process, the processing proceeds to step S251.

In step S211, the instruction unit 23 divides the processing according to the state at the time of occurrence of the alarm.

At the time of occurrence of the alarm, in a case before standing by execution of the handling execution process, such as during execution of the pre-execution process or before activation of the workflow, the processing proceeds to step S221. In step S221, the instruction unit 23 sets a monitoring period. In step S222, the instruction unit 23 instructs the control unit 21 to stand by execution of the handling execution process.

In a case where the execution of the handling execution process is on standby at the time of occurrence of the alarm, the processing proceeds to step S231. In a case where the alarm occurrence status satisfies the predetermined condition indicating that immediate handling of a failure is taken in step S231, the instruction unit 23 instructs the control unit 21 to execute the handling execution process during standby in step S232. In a case where the predetermined condition is not satisfied, the instruction unit 23 ends the process.

In a case where the handling execution process has been executed at the time of occurrence of the alarm, the processing proceeds to step S241. In step S241, in a case where the alarm indicates that the failure that has triggered the execution of the workflow including the handling execution process has not been resolved, the instruction unit 23 instructs the control unit 21 to execute a new workflow in step S242. In a case where the alarm indicates a possibility that the failure has been resolved without being able to determine that the failure has not been resolved, the instruction unit 23 ends the processing.

In step S201, in a case where each monitoring period expires while standing by execution of the handling execution process, the processing proceeds to step S251. In step S251, the instruction unit 23 divides the processing according to the alarm type that has been occurred most recently. In a case where the alarm type that has been occurred most recently is a failure, in step S252, the instruction unit 23 instructs the control unit 21 to cancel the standby of the handling execution process and to execute the handling execution process and ends the process. In a case where the alarm type that has been occurred most recently is recovery, in step S253, the instruction unit 23 instructs the control unit 21 to cancel the execution of the handling execution process and ends the process.

The calculation unit 24 calculates a monitoring period set by the instruction unit 23. The monitoring period is calculated so as to have a positive correlation with the alarm occurrence interval. The monitoring period calculated in response to the occurrence of the alarm is notified to the instruction unit 23. When the alarm occurrence interval is short, the monitoring period is short, and when the alarm occurrence interval is long, the monitoring period is long. The execution timing of the handling execution process can be adjusted according to the urgency of the handling indicated by the alarm occurrence frequency.

When the execution of the handling execution process is detected during the monitoring period, the calculation unit 24 updates the monitoring period so that a time positively correlated with a time used for executing the handling execution process is added to the monitoring period. When the execution of the handling execution process is detected, the calculation unit 24 updates the monitoring period and the timer count of the monitoring data 12. While a handling is taken in the handling execution process, the occurrence of an alarm may be temporarily stopped. Therefore, the calculation unit 24 extends the monitoring period by a time used for completing the execution of the handling execution process in consideration of the temporary stop of the alarm accompanying the handling by the handling execution process. The time used for executing the handling execution process is defined by the handling time data 13. As a result, the instruction unit 23 can determine the instruction on the handling execution process during standby according to the alarm occurrence status at the time when the execution of the handling execution process is completed. Examples of the method of detecting the execution of the handling execution process include a method in which the calculation unit 24 monitors and detects the execution of the handling execution process, a method in which the execution of the handling execution process is notified from the control unit 21, and a method in which a log recording the execution of the handling execution process is referred to.

In addition, when the execution of the handling execution process is detected, the calculation unit 24 may specify a monitoring period for an alarm related to the alarm that has triggered the detected handling execution process among the monitoring periods in progress at that time and update the specified monitoring period. The alarm relation means that there is a high possibility of being related to a fault, for example, failed apparatuses are the same or are in an adjacent or connected relationship.

An example of an equation for calculating the monitoring period is shown in Equation (1).

$$\begin{matrix}[ Math . 1 ] & \\ \begin{matrix}{Term}_{{t}_{n}^{a l {m}^{F}}} = f ( Δ {t}_{n}^{{alm}^{F}} ) + {E}_{{g}_{n}}^{a l {m}^{F}} \\ = α ( {t}_{n}^{{alm}^{F}} - {t}_{n - 1}^{a l {m}^{F}} ) + β * {p}_{{g}_{n}}^{a l {m}^{F}} ⋆ \\ {S}_{{g}_{n}}^{{alm}^{F}} {t}_{n} \leq {g}_{n} \leq {t}_{n} + {Term}_{{t}_{n}^{{alm}^{F}}}\end{matrix} & Equation ( 1 )\end{matrix}$$

alm^{f}: Alarm group related to failure F
n: N-th occurred alarm in alarm group related to failure F
tₙ^{alm} Occurrence time of n-th occurred alarm
Term: Monitoring period after occurrence of alarm
gₙ: Start time of handling started during monitoring period of n-th occurred alarm
α,β: Any constant
P: Execution time for each handling
S: Presence or absence of handling execution (present: 1, absent: 0)

In Equation (1), f is a function for calculating the monitoring time from the alarm occurrence interval, and E is a function for calculating the time used for performing the handling execution process. n is an identifier of an alarm in the alarm group related to a failure F. The alarm group related to the failure F includes an alarm indicating the failure and an alarm indicating recovery of the failure. Equation (1) indicates that the monitoring period is calculated by the sum of the time positively correlated with the alarm occurrence interval and the time positively correlated with the time used for performing the handling execution process when the handling execution process is started. The handling start time may be a time at which the calculation unit 24 detects the execution of the handling, may be a time notified from the control unit 21, may be a time specified by a log or the like, or may be specified by another method.

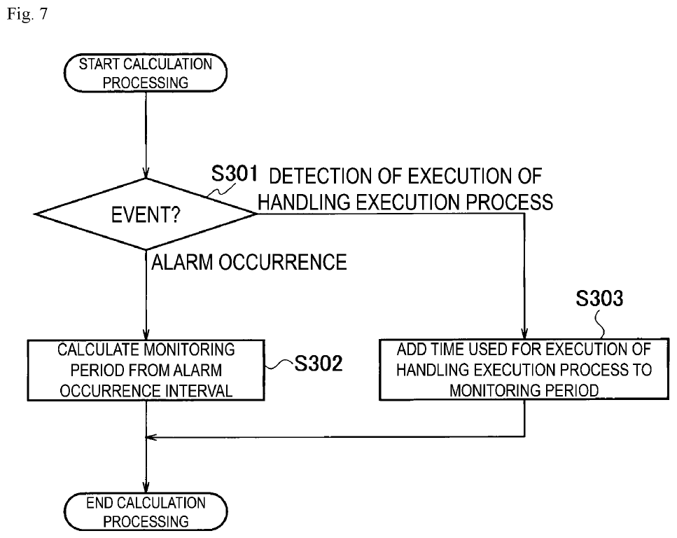

Calculation processing by the calculation unit 24 will be described with reference to FIG. 7. The order of the processing illustrated in FIG. 7 is an example, and the present disclosure is not limited thereto.

In step S301, the calculation unit 24 divides the processing according to the occurred event. In a case where an alarm is occurred, the processing proceeds to step S302, and in a case where the execution of the handling execution process is detected, the processing proceeds to step S303.

In step S302, when an alarm is occurred, the calculation unit 24 calculates a monitoring period from an alarm occurrence interval and ends the processing. The calculated monitoring period is provided to the instruction unit 23.

When the execution of the handling execution process is detected, the calculation unit 24 adds the time used for executing the handling execution process to the monitoring period currently in progress in step S303 and ends the process. In accordance with the monitoring period to which the time used for executing the handling process has been added, the instruction unit 23 stands by the expiration of the monitoring period.

As described above, the control apparatus 1 according to the embodiment of the present disclosure can adjust the execution timing of the handling execution process according to the alarm occurrence status and provide an appropriate monitoring period. Specifically, the control apparatus 1 can avoid a situation in which the execution of the same handling execution process is repeated a plurality of times, the handling execution process is executed even though the spontaneous recovering has occurred, or the like. In addition, the control apparatus 1 immediately executes the handling execution process in a case where a situation to be dealt with immediately occurs while standing by the execution of the handling execution process, and thus, does not miss an opportunity to execute the handling execution process. In addition, the control apparatus 1 can determine a handling detail after grasping the cause of the occurrence of the alarm by confirming the alarm occurrence status during the monitoring period.

The control apparatus 1 according to the embodiment of the present disclosure can appropriately handle the failure of the controlled apparatus 2 by using the workflow.

As the control apparatus 1 of the present embodiment described above, a general-purpose computer system including a central processing unit (CPU) (a processor) 901, a memory 902, a storage 903 (a hard disk drive (HDD) or a solid state drive (SSD)), a communication device 904, an input device 905, and an output device 906 is used. In the computer system, each function of the control apparatus 1 is implemented by the CPU 901 executing a control program loaded on the memory 902.

The control apparatus 1 may be implemented on one computer or may be implemented on a plurality of computers. Further, the control apparatus 1 may be a virtual machine implemented on a computer.

The control program for the control apparatus 1 may be stored in a computer-readable recording medium such as a HDD, a SSD, a universal serial bus (USB) memory, a compact disc (CD), or a digital versatile disc (DVD) or may be distributed via a network.

The present disclosure is not limited to the above embodiment, and various modification may be made within the scope of its gist.

### REFERENCE SIGNS LIST

1 Control apparatus
2 Controlled apparatus
11 Workflow data
12 Monitoring data
13 Handling time data
21 Control unit
22 External information acquisition unit
23 Instruction unit
24 Calculation unit
901 CPU
902 Memory
903 Storage
904 Communication device
905 Input device
906 Output device

1. A control apparatus, comprising:
a control unit, including one or more processors, configured to control execution of a workflow including a handling execution process when an alarm indicating a failure is occurred; and
an instruction unit, including one or more processors, configured to instruct the control unit to
stand by execution of the handling execution process when the handling execution process is capable of being executed before a monitoring period started in response to occurrence of an alarm indicating the failure or a recovery expires; and
when the monitoring period expires, execute the handling execution process in a case where an alarm that is occurred most recently indicates the failure, and cancel the execution of the handling execution process in a case where the alarm that is occurred most recently indicates the recovery.

2. The control apparatus according to claim 1, wherein
the monitoring period is calculated to have a positive correlation with an alarm occurrence interval.

3. The control apparatus according to claim 1, wherein, when the execution of the handling execution process is detected during the monitoring period, a time positively correlated with a time used for the execution of the handling execution process is added to the monitoring period.

4. The control apparatus according to claim 1,
wherein the monitoring period is set every time the alarm is occurred, and
the instruction unit is configured to instruct the execution or cancellation of the handling execution process when the monitoring period expires.

5. The control apparatus according to claim 1, wherein, after instructing to stand by the execution of the handling execution process, the instruction unit is configured to instruct the execution of the handling execution process when an alarm occurred during the monitoring period satisfies a predetermined condition.

6. The control apparatus according to claim 1, wherein the instruction unit is configured to instruct execution of a new workflow when an alarm occurred after the execution of the handling execution process indicates that the failure that is triggered the execution of the workflow including the handling execution process is not resolved.

7. A control method, comprising:
by a computer, controlling execution of a workflow including a handling execution process when an alarm indicating a failure is occurred;
by the computer, instructing to stand by execution of the handling execution process when the handling execution process is capable of being executed before any one of monitoring periods each started in response to occurrence of an alarm indicating the failure or a recovery expires; and
when the monitoring periods expire, by the computer, instructing to execute the handling execution process in a case where an alarm corresponding to a monitoring period most recently expired of the monitoring periods indicates the failure, and cancelling the execution of the handling execution process in a case where the alarm corresponding to the monitoring period most recently expired indicates the recovery.

8. A non-transitory computer-readable medium storing a control program that causes a computer to operate as the control apparatus to perform operations comprising:
controlling execution of a workflow including a handling execution process when an alarm indicating a failure is occurred;
instructing to stand by execution of the handling execution process when the handling execution process is capable of being executed before any one of monitoring periods each started in response to occurrence of an alarm indicating the failure or a recovery expires; and
when the monitoring periods expire, instructing to execute the handling execution process in a case where an alarm corresponding to a monitoring period most recently expired of the monitoring periods indicates the failure, and cancelling the execution of the handling execution process in a case where the alarm corresponding to the monitoring period most recently expired indicates the recovery.

9. The control method according to claim 7, wherein
the monitoring period is calculated to have a positive correlation with an alarm occurrence interval.

10. The control method according to claim 7, wherein, when the execution of the handling execution process is detected during the monitoring period, a time positively correlated with a time used for the execution of the handling execution process is added to the monitoring period.

11. The control method according to claim 7,
wherein the monitoring period is set every time the alarm is occurred, and
the method comprises instructing the execution or cancellation of the handling execution process when the monitoring period expires.

12. The control method according to claim 7, further comprising, after instructing to stand by the execution of the handling execution process, instructing the execution of the handling execution process when an alarm occurred during the monitoring period satisfies a predetermined condition.

13. The control method according to claim 7, further comprising: instructing execution of a new workflow when an alarm occurred after the execution of the handling execution process indicates that the failure that is triggered the execution of the workflow including the handling execution process is not resolved.

14. The non-transitory computer-readable medium according to claim 8, wherein
the monitoring period is calculated to have a positive correlation with an alarm occurrence interval.

15. The non-transitory computer-readable medium according to claim 8, wherein, when the execution of the handling execution process is detected during the monitoring period, a time positively correlated with a time used for the execution of the handling execution process is added to the monitoring period.

16. The non-transitory computer-readable medium according to claim 8,
wherein the monitoring period is set every time the alarm is occurred, and
the operations comprise instructing the execution or cancellation of the handling execution process when the monitoring period expires.

17. The non-transitory computer-readable medium according to claim 8, wherein the operations further comprise, after instructing to stand by the execution of the handling execution process, instructing the execution of the handling execution process when an alarm occurred during the monitoring period satisfies a predetermined condition.

18. The non-transitory computer-readable medium according to claim 8, wherein the operations further comprise: instructing execution of a new workflow when an alarm occurred after the execution of the handling execution process indicates that the failure that is triggered the execution of the workflow including the handling execution process is not resolved.
